(19) United States
(12) Patent Application Publication
(10) Pub. No.: US 2005/0121315 A1
(43) Pub. Date: Jun. 9, 2005

(54) System for generating hydrogen and method thereof

(76) Inventors: Justin Damien Baltrucki, Marlborough, CT (US); A. John Speranza, West Hartfor, CT (US); Michael Aaron Spaner, Deep River, CT (US); Curt Copeland Ebner, Wethersfield, CT (US); Ken Wayne Dreier, Madison, CT (US); Stephen Arthur Goyette, New Hartford, CT (US); Lawrence Clinton Moulthrop, Windsor, CT (US); Matthew J. Christopher, Manchester, CT (US)

Correspondence Address: PROTON ENERGY SYSTEM, 10 TECHNOLOGY DRIVE, WALLINGFORD, CT, 06492, US

(21) Appl. No.: 11/004,185

(22) Filed: Dec. 3, 2004

Related U.S. Application Data
(60) Provisional application No. 60/481,744, filed on Dec. 5, 2003.

(51) Int. Cl. B23H 7/04; C25B 15/00

(52) U.S. Cl. 204/228.4

(57) ABSTRACT

An electrochemical system having a plurality of discrete electrochemical cell stacks is described. The system includes a water-oxygen management system fluidly coupled to the plurality of electrochemical cell stacks and a hydrogen management system fluidly coupled to the plurality of electrochemical cells. A means for ventilating the system and a control system for monitoring and operating said electrochemical system, said control system including a means for detecting abnormal operating conditions and a means for degrading the performance of said electrochemical system in response to said abnormal condition.

### CROSS REFERENCE TO RELATED APPLICATIONS

The present application claims priority to Provisional Application Ser. No. 60/481,744 filed on Dec. 3, 2003 which is incorporated herein by Reference.

### FIELD OF INVENTION

The present disclosure relates to an electrochemical cell system and especially relates to the use of multiple electrochemical cells in a single system.

### BACKGROUND OF INVENTION

Electrochemical cells are energy conversion devices, usually classified as either electrolysis cells or fuel cells. An electrolysis cell functions as a hydrogen generator by electrolytically decomposing water to produce hydrogen and oxygen gases, and functions as a fuel cell by electrochemically reacting hydrogen with oxygen to generate electricity. Referring to FIG. 1, a partial section of a typical proton exchange membrane electrolysis cells is detailed. In a typical anode feed water electrolysis cell (not shown), process water is fed into a cell on the side of the oxygen electrode (in an electrolytic cell, the anode) to form oxygen gas, electrons, and protons. The electrolytic reaction is facilitated by the positive terminal of a power source electrically connected to the anode and the negative terminal of the power source connected to a hydrogen electrode (in an electrolytic cell, the cathode).

The oxygen gas and a portion of the process water exit the cell, while protons and water migrate across the proton exchange membrane to the cathode where hydrogen gas is formed. In a cathode feed electrolysis cell (not shown), process water is fed on the hydrogen electrode, and a portion of the water migrates from the cathode across the membrane to the anode where protons and oxygen gas are formed. A portion of the process water exits the cell at the cathode side without passing through the membrane. The protons migrate across the membrane to the cathode where hydrogen gas is formed. The typical electrochemical cell system includes a number of individual cells arranged in a stack, with the working fluid directed through the cells via input and output conduits formed within the stack structure. The cells within the stack are sequentially arranged, each including a cathode, a proton exchange membrane, and an anode.

In certain conventional arrangements, the anode, cathode, or both are gas diffusion electrodes that facilitate gas diffusion to the membrane. Each cathode/membrane/anode assembly (hereinafter “membrane electrode assembly”, or “MEA”) is typically supported on both sides by flow fields comprising screen packs or bipolar plates. Such flow fields facilitate fluid movement and membrane hydration and provide mechanical support for the MEA. Since a differential pressure often exists in the cells, compression pads or other compression means are often employed to maintain uniform compression in the cell active area, i.e., the electrodes, thereby maintaining intimate contact between flow fields and cell electrodes over long time periods. Pumps are used to move the reactants and products to and from the electrochemical cell, which is connected to the liquid and gas storage devices by a system of pipes. This use of external pumps and storage areas both limits the ease with which electrochemical cells may be transported, and complicates the use of electrochemical cells in locations where pumps and storage tanks are difficult to introduce or operate. While existing electrochemical cell systems are suitable for their intended purposes, there still remains a need for improvements, particularly regarding operation of electrochemical cell systems with multiple electrochemical cell stacks and their operation.

### SUMMARY OF INVENTION

An electrochemical system having a plurality of discrete electrochemical cell stacks. The system includes a water-oxygen management system fluidly coupled to the plurality of electrochemical cell stacks and a hydrogen management system fluidly coupled to the plurality of electrochemical cells. A means for ventilating the system and a control system for monitoring and operating said electrochemical system, said control system including a means for detecting abnormal operating conditions and a means for degrading the performance of said electrochemical system in response to said abnormal condition.

An electrochemical system having a plurality of discrete electrochemical cell stacks, said system including a oxygen-water phase separator fluidly connected to the plurality of electrochemical cell stacks. The phase separator having a first manifold for discharging water to the electrochemical cell stacks and second manifold for receiving water from the electrochemical cell stacks. The first manifold includes a plurality of cell stack outlets for discharging water to the electrochemical cells and a guard bed outlet. An exhaust conduit is fluidly coupled to the phase separator, the conduit includes an inlet for receiving a gas stream from the phase separator and an exhaust port for discharging the gas stream. The system also includes a flow reducer coupled to the first manifold guard bed outlet. The flow reducer restricts the volume of water through the guard bed outlet over a range of pressures.

A system for automatically calibrating combustible gas sensors including a user interface and a control panel connected to the user interface. A canister of premixed combustible gas and at least one combustible gas sensor electrically coupled to the control panel. A valving arrangement is provided which is fluidly coupled to the canister and the at least one combustible gas sensor. The valving arrangement is also electrically connected to the control panel.

A method for automatically calibrating a combustible gas sensor including automatically discharging premixed combustible gas at a predetermined interval and injecting the premixed combustible gas onto the sensing surface of a combustible gas sensor. The measuring the level of combustible gas detected by the sensor and the automatic adjusting of the calibration of the sensor in response to the measurement.

A system for controlling the output pressure of an electrochemical system including at least one electrochemical cell. A pressure regulator having a set point, the pressure regulator being fluidly coupled to the electrochemical cell. A pressure sensor is fluidly coupled to the pressure regulator between the pressure regulator and the electrochemical cell. A control panel monitors the pressure sensor and a means for controlling output of the electrochemical cell response to the pressure sensor wherein the gas pressure at the pressure sensor is maintained at a predetermined pressure above the pressure regulator set point.

### BRIEF DESCRIPTION OF DRAWINGS

Referring now to the drawings, which are meant to be exemplary and not limiting, and wherein like elements are numbered alike:

FIG. 1 is a schematic diagram of a partial prior art electrochemical cell showing an electrochemical reaction;

FIG. 2 is an illustration in a perspective view of an exemplary embodiment of a hydrogen generation system;

FIG. 3 is an illustration of a piping and instrumentation diagram of the hydrogen generation system of FIG. 2;

FIG. 4 is a perspective view illustration of the water management system of FIG. 2;

FIG. 5 is a perspective view illustration of a oxygen-water phase separator and water management manifold of FIG. 2;

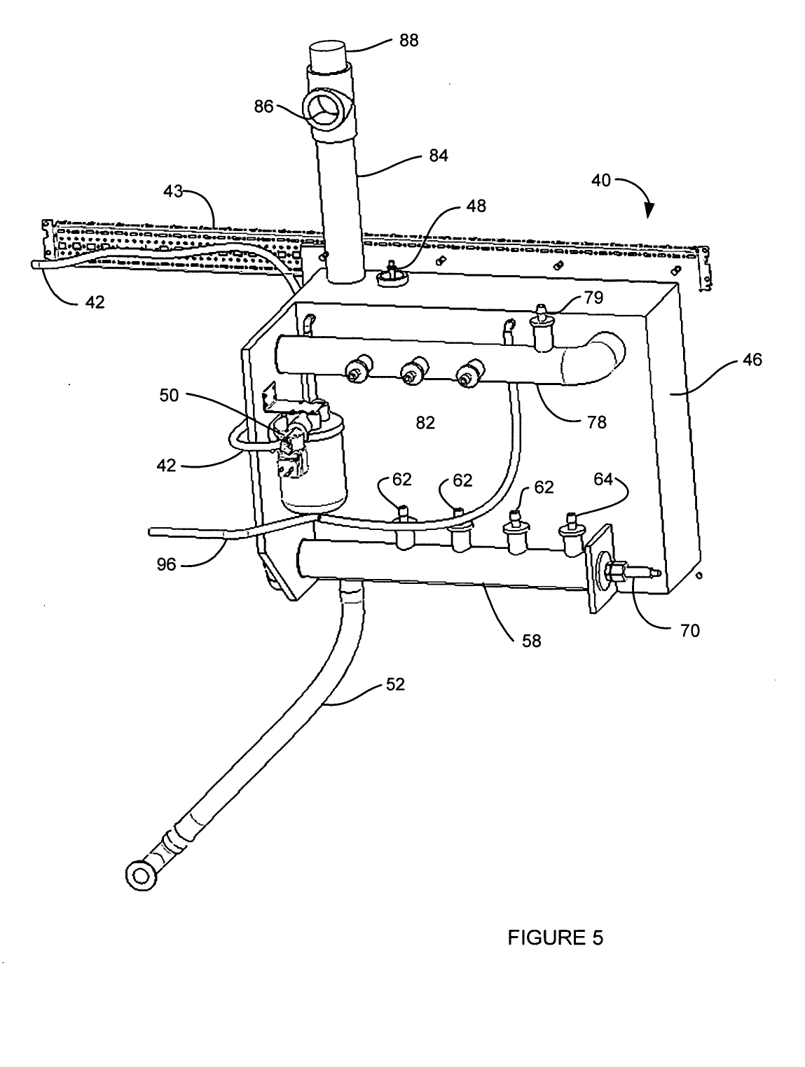

FIG. 6 is a plan view illustration of a water deionizing filter and water restrictor of FIG. 2;

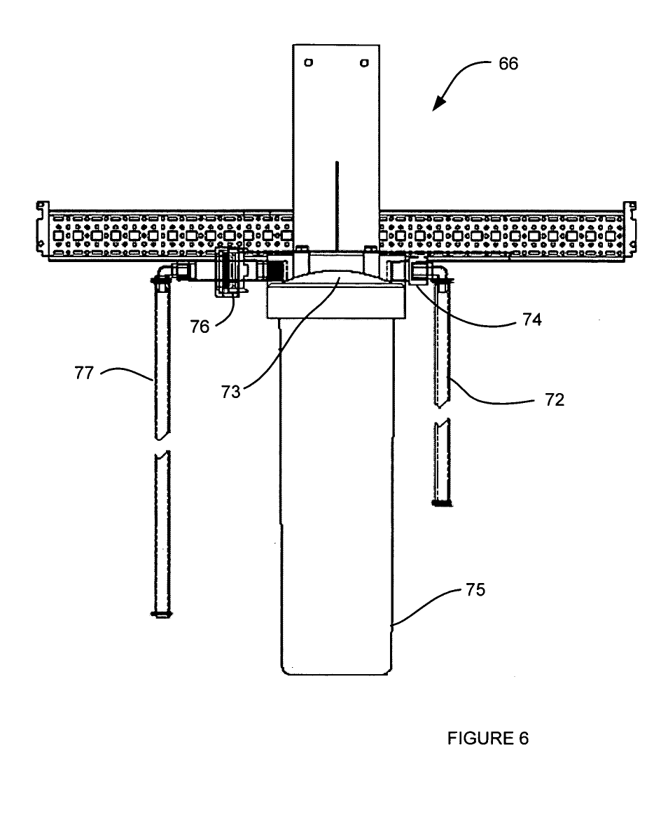

FIG. 7 is a state transition diagram illustrating an exemplary embodiment for control methodology in degraded modes of operation due to excessive LEL levels;

FIG. 8 is a state transition diagram illustrating an exemplary embodiment for control methodology in degraded modes of operation due to high water temperature;

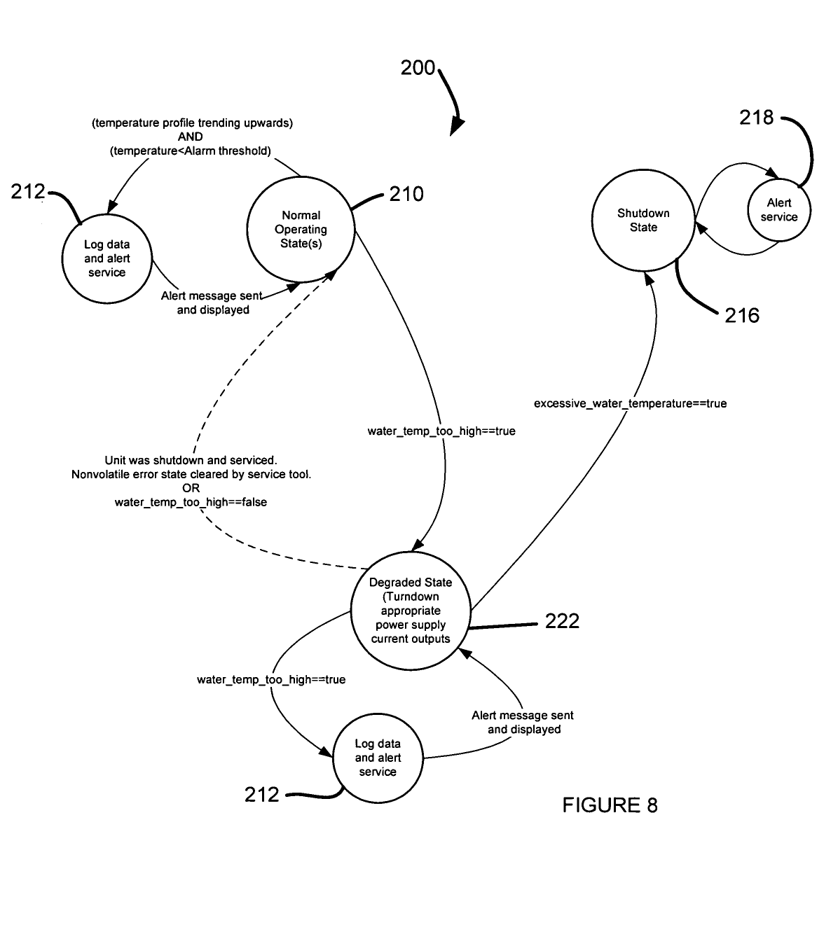

FIG. 9 is a state transition diagram illustrating an exemplary embodiment for control methodology in degraded modes of operation due to high or low electrochemical cell voltage;

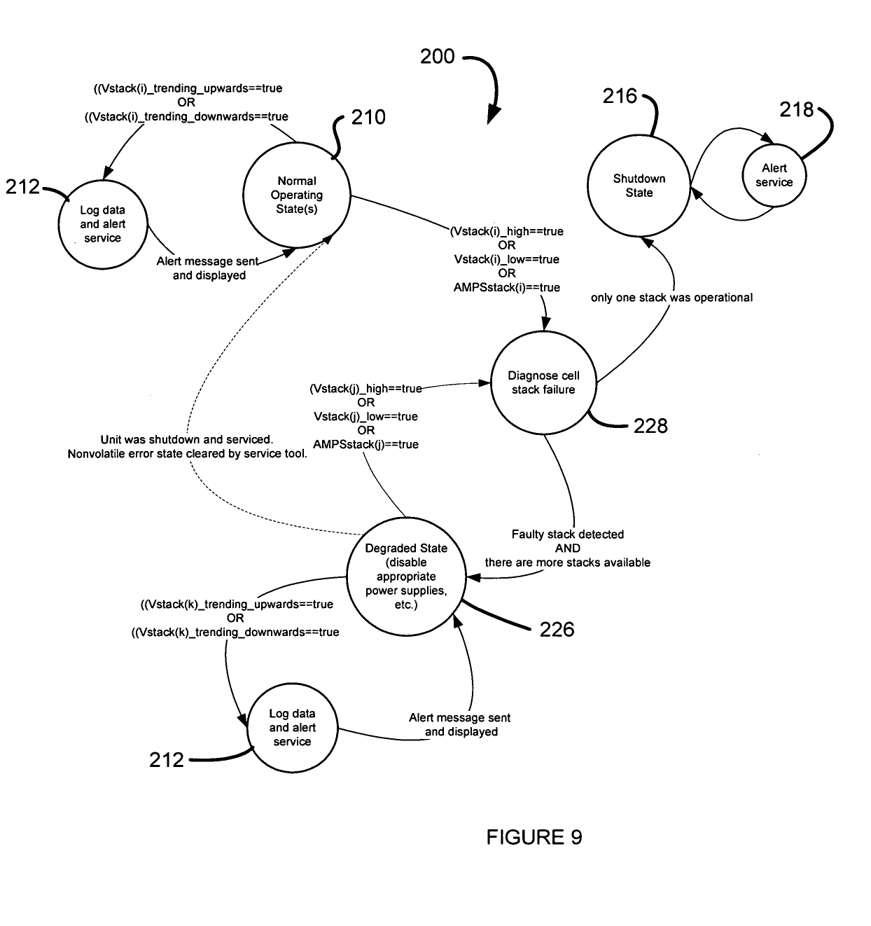

FIG. 10 is a state transition diagram illustrating an exemplary embodiment for control methodology in degraded modes of operation due to a power supply failure;

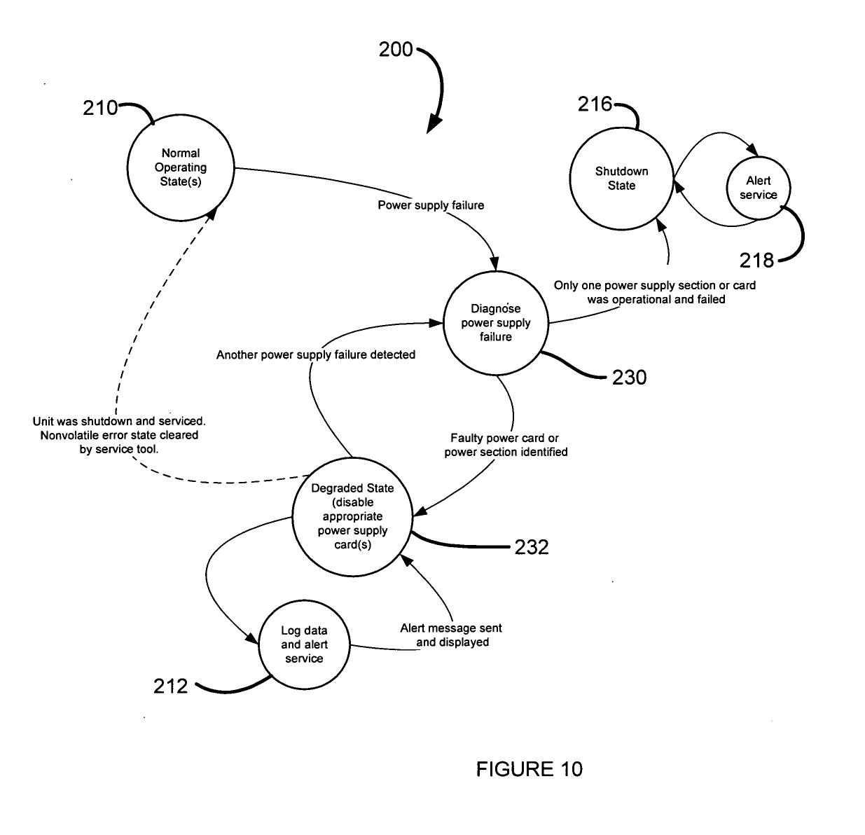

FIG. 11 is a state transition diagram illustrating an exemplary embodiment for control methodology in degraded modes of operation due to low inlet dionized water flow.

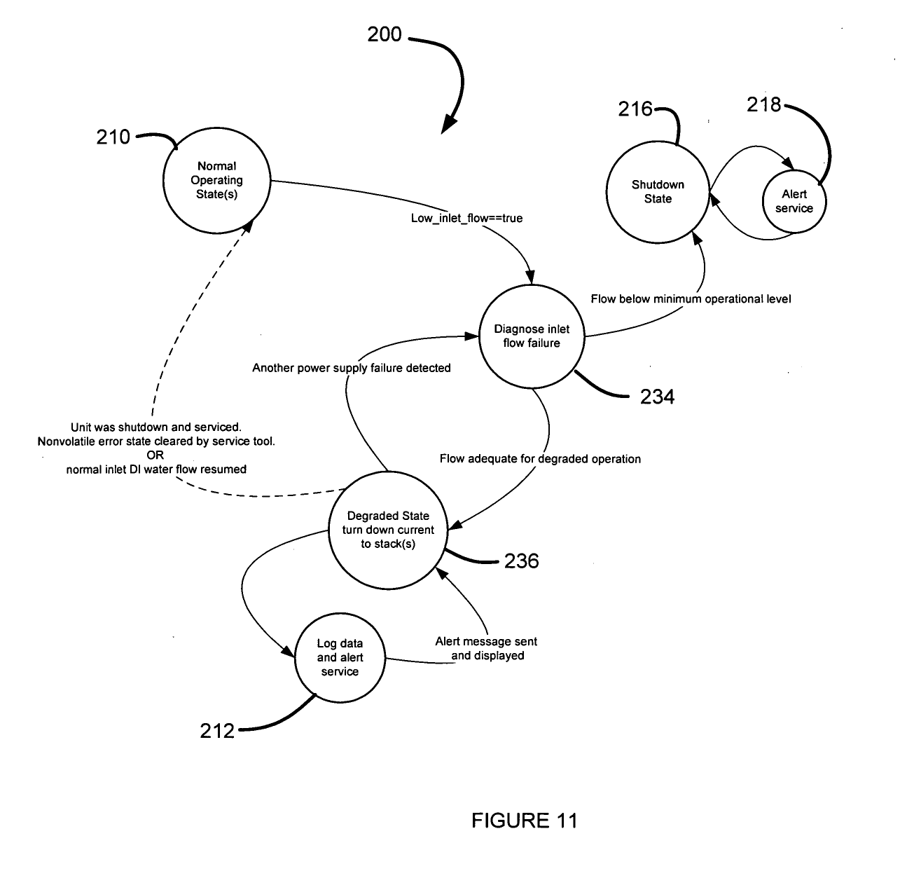

### DETAILED DESCRIPTION

Hydrogen gas is a versatile material having many uses in industrial and energy application ranging from the production of ammonia, and cooling of electrical generators to the powering of vehicles being propelled into space. While being the most abundant element in the universe, hydrogen gas is not readily available, and must be extracted from other material. Typically, large production facilities which reform methane through a steam reduction process are used to create large quantities of hydrogen gas which is then stored in containers or tanks and shipped to a customer for use in their application.

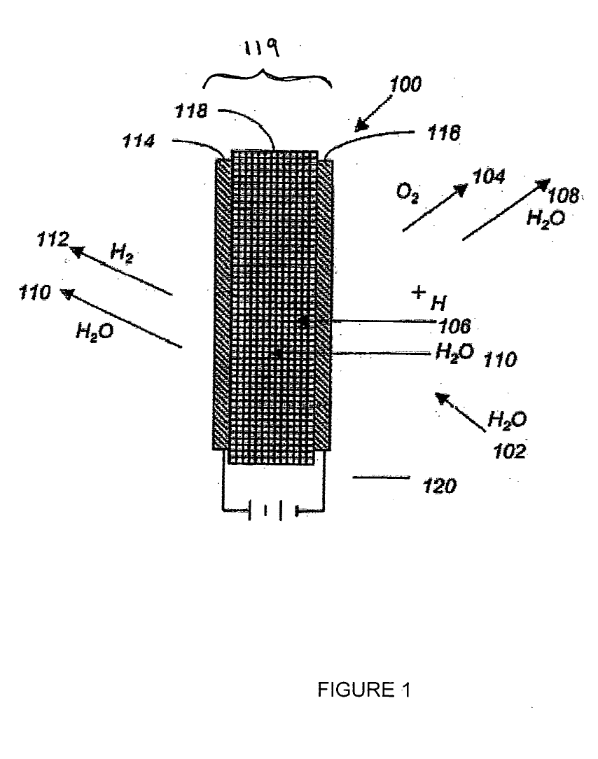

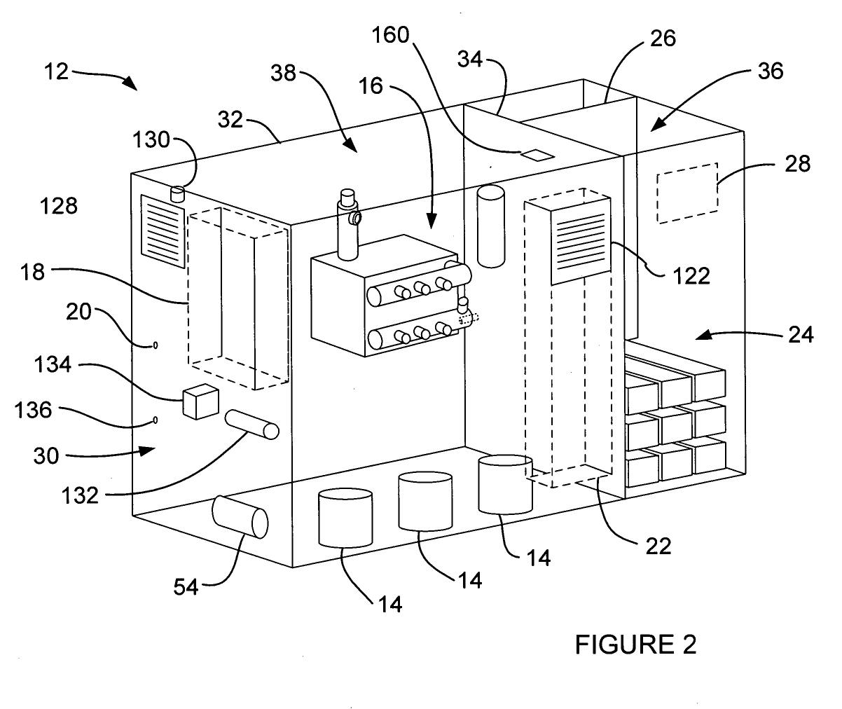

Increasing, due to logistics and security concerns, it has become more desirable to produce the hydrogen closer to the end point of use. The most desirable method of production allows the user to produce the hydrogen as it is needed at the point of use. To achieve this, hydrogen generators using water electrolysis are used to produce the hydrogen gas as it is needed. Referring to FIG. 1 and FIG. 2, and electrochemical system 12 of the present invention is shown. Electrochemical cells 14 typically include one or more individual cells arranged in a stack, with the working fluids directed through the cells within the stack structure. The cells within the stack are sequentially arranged, each including a cathode, proton exchange membrane, and an anode (hereinafter “membrane electrode assembly”, or “MEA” 119) as shown in FIG. 1. Each cell typically further comprises a first flow field in fluid communication with the cathode and a second flow field in fluid communication with the anode. The MEA 119 may be supported on either or both sides by screen packs or bipolar plates disposed within the flow fields, and which may be configured to facilitate membrane hydration and/or fluid movement to and from the MEA 119.

Membrane 118 comprises electrolytes that are preferably solids or gels under the operating conditions of the electrochemical cell. Useful materials include, for example, proton conducting ionomers and ion exchange resins. Useful proton conducting ionomers include complexes comprising an alkali metal salt, alkali earth metal salt, a protonic acid, a protonic acid salt or mixtures comprising one or more of the foregoing complexes. Counter-ions useful in the above salts include halogen ion, perchloric ion, thiocyanate ion, trifluoromethane sulfonic opn, borofuoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt can be complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenesl; and esters, such as phosphoric acid esters, aliphatic carboxylic acid esters or aromatic carboxylic acid esters of the above polyoxyalkylenes. Copolymers of, e.g., polyethylene glycol monoethyl ether with methacrylic acid exhibit sufficient ionic conductivity to be useful.

Ion-exchange resins useful as proton conducting materials include hydrocarbon and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene, styrene-divinylbenzene-vinylchloride terpolymers, and the like, that can be imbued with cation-exchange ability by sulfonation, or can be imbued with anion-exchange ability by chloromethylation followed by conversion to the corresponding quaternaryamine.

Fluorocarbon-type ion-exchange resins can include, for example, hydrates of tetrafluoroethylene-perfluorosulfonyl ethoxyvinyl ether or tetrafluoroethylene-hydroxylated (perfluorovinylether) copolymers and the like. When oxidation and or acid resist is desirable, for instance, at the cathode of a fuel cell, fluorocarbon-type resins having sulfonic, carboxylic and/or phosophoric acid functionality are preferred. Fluorocarbon-type resins typically exhibit excellent resistance to oxidation by halogen, strong acids, and bases. One family of fluorocarbon-type resins having sulfonic acid group functionality is NAFION™ resins (commercially available from E.I. du Pont de Nemours and Company, Wilmington, Del.).

Electrodes 114 and 116 comprise catalyst suitable for performing the needed electrochemical reaction (i.e. electrolyzing water to produce hydrogen and oxygen). Suitable electrodes comprise, but are not limited to, platinum, palladium, rhodium, carbon, gold, tantalum, tungsten, ruthenium, iridium, osmium, and the like, as well as alloys and combinations comprising one or more of the foregoing materials. Electrodes 114 and 116 can be formed on membrane 118, or may be layered adjacent to, but in contact with or in ionic communication with, membrane 118.

Flow field members (not shown) and support membrane 118, allow the passage of system fluids, and preferably are electrically conductive, and may be, for example, screen packs or bipolar plates. The screen packs include one or more layers of perforated sheets or a woven mesh formed from metal or strands. These screens typically comprise metals, for example, niobium, zirconium, tantalum, titanium, carbon steel, stainless steel, nickel, cobalt and the like, as well as alloys and combinations comprising one or more of the foregoing metals. Bipolar plates are commonly porous structures comprising fibrous carbon, or fibrous carbon impregnated with polytetrafluoroethylene or PTFE (commercially available under the trade name TEFLON® from E.I. du Pont de Nemours and Company).

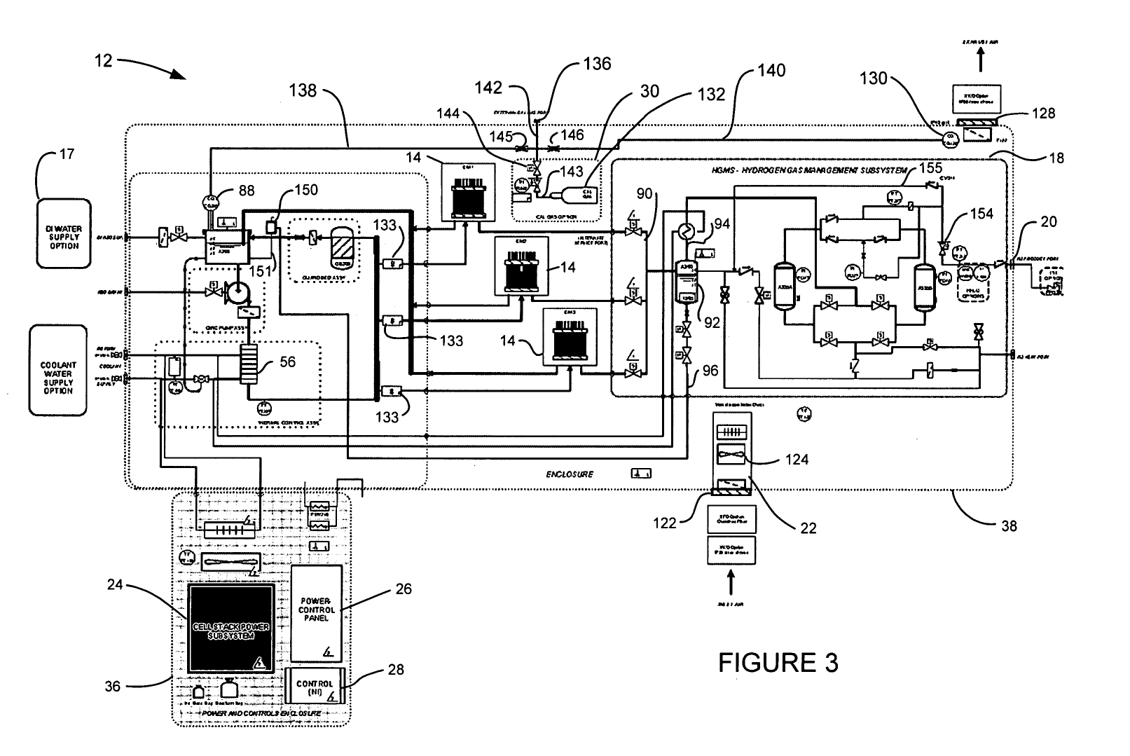

Referring now to FIGS. 2 and FIG. 3, after the water is decomposed in the electrochemical cells 14 into hydrogen and oxygen gas, the respective gases leave the electrochemical cells 14 for further downstream processing. The oxygen, mixed with process water which was not decomposed, is directed into a water oxygen management system 16 (herein after referred to as “WOMS”). The WOMS 16 maintains all of the water fluid functions within the electrochemical system 12, including separating the oxygen gas from the water, manifolding of water lines, monitoring of water quality, deionizing of the water, all of which will be described in more detail herein.

The hydrogen gas exits the electrochemical cells 14 along with a small amount of water which is carried over with the hydrogen protons during the process of electrolyzing the water. This hydrogen-water mixture is directed into a hydrogen gas management system 18 (hereinafter referred to as “HGMS”) for further processing. The HGMS 18 separates the water from the hydrogen gas and processes the gas using optional drying apparatus to further minimize water contamination. Finally, the hydrogen gas exits the system 12 through a port 20 for use in the end application.

The electrochemical system 12 includes further subsystems, such as a ventilation system 22, power supply modules 24, control panels 26, a user input panel 28 and combustible gas sensor calibration system 30. If should be noted that the cabinet 32 of electrochemical system 12 is divided by a partition 34 which separates the electrical compartment 36 from the gas generation compartment 38 to prevent any inadvertent exposure of hydrogen gas to ignition sources.

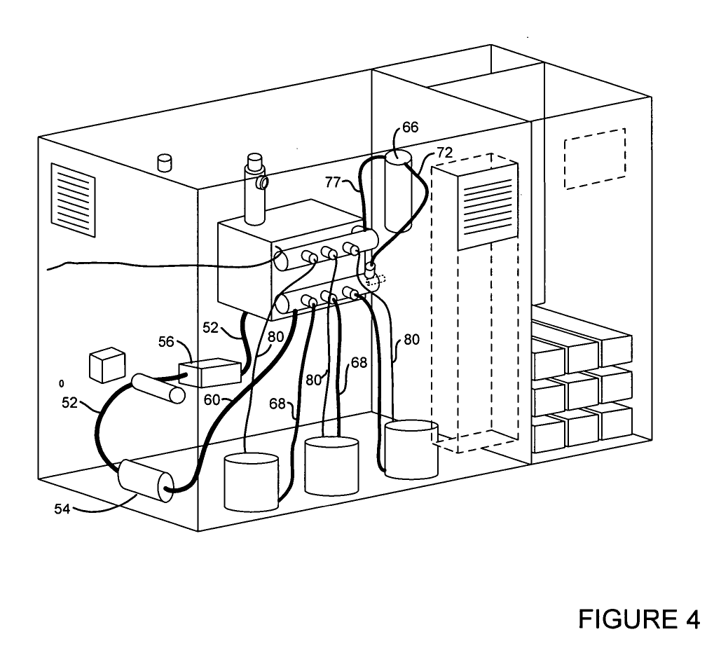

The WOMS 16 is best seen in FIG. 4 6. Deionized water is fed from an external source to the phase separator and water manifold 40 via a water inlet conduit 42. An optional filter 44 may be coupled to the water inlet conduit 42 to provide additional protection against contaminants from entering the system 12. Upon startup of the system 12, water enters via conduit 42 filling the phase separator body 46 until the desired water level is detected by sensor 48 causing the solenoid valve 50 to close. During operation, when the water level sensor 48 detects the water level in the phase separator drop below a predetermined threshold, the solenoid valve 50 opens to provide additional water to the system. The phase separator and water manifold 40 is mounted to the cabinet by bracket 43.

Once the appropriate water level is achieved and the system 12 is operating, water is discharged from the phase separator body 46 through conduit 52 to pump 54. An optional heat exchanger 56 may be used to reduce the temperature of the water. After leaving the pump 54, the water enters the manifold 58 via conduit 60. A plurality of outlets 62 and 64 provide water to the electrochemical cells 14 and the guard bed 66. Outlets 62 feed water via conduits 68 past flow switches 133 to the electrochemical cells 14. Flow switches 133 are electrically connected to the control circuits of power supply 24. In the event that flow is interrupted in conduit 68, the flow switch will send a signal to the power supply 24 which causes the electrical power to be disconnected to the electrochemical cell 14 which the interrupted conduit was providing water. Any additional water not directed to the electrochemical cells 14 exits the manifold 58 via outlet 64 to be filtered by guard bed 66. As will be explained in more detail herein, the guard bed 66 includes a restrictor for preventing excess flow through outlet 64 which prevents the electrochemical cells 14 from being starved of water which could adversely effect their performance and reduce their operating life. Manifold 58 also includes a conductivity sensor 70 which measures the quality of the water in the system 12. The sensor 70 is typically a water conductivity and temperature sensor (commercially available as Model RC-20/PS102J2 manufactured by Pathfinder Instruments). Since these types of sensor require the water to be flowing in order to maintain accurate measurements, the placement of the sensor 70 is important. By placing the sensor 70 at the end of the manifold 58 adjacent to the outlet to guard bed 66, two functions may be accomplished by sensor 70. First, the sensor 70 will measure the quality of the water. Once the water quality falls below a predetermined threshold, typically 1 to 5 microSiemens/cm, the system 12 will be shut down to prevent contaminants from damaging the electrochemical cells 14. Additionally, since the sensor 70 requires flowing water for accurate measurements, if the guard bed, or any of the conduits or valves attached thereto become plugged, the water will stop flowing and the conductivity sensor 70 will also read an erroneously high conductivity, which will indicate to the system 12 that there is a problem and the process should be shut down.

Once the water enters outlet 64, it moves to the guard bed 66 via conduit 72. The guard bed 66 includes a manifold 73 which receives the water from conduit 72 and forces the water through a screen 74 which filter any particulate matter from entering the main body 75 of the guard bed 66. After being treated in the body 75, the water exits the guard bed 66 through the manifold 73 via a volume restrictor 76. The restrictor 76 (commercially available under Model 58.6271.1 manufactured by Neoperl, Inc.) limits the amount volume that can pass through the guard bed 66 over a wide range of pressures. By knowing the output of pump 54 and operating requirements of electrochemical cells 14, the restrictor 76 can be appropriately sized to maintain a water volume flowing through the guard bed 66 at a level that maintains adequate water flow to the electrochemical cells 14. Water returns from the guard bed 66 to the inlet 79 in return manifold 78 via conduit 77.

As described herein above, after the water is decomposed into hydrogen and oxygen gas by electrochemical cells 14, the oxygen-water mixture returns to the phase separator 40 via conduits 80. Return manifold 78 receives the conduct 80 through inlets 82. The oxygen-water mixture travels along the return manifold 78 which empties into the phase separator body 46. As the mixture enters the body 46, it impinges on the inner walls and surfaces, causing the water to separate under the influence of gravity and surface tension out of the gas and collect in the bottom of the separator body 46. The liberated gas exits the separator body 46 via conduit 84 and exhausts into the cabinet 32 through outlet 86. A combustible gas sensor 88 monitors the gas exiting the outlet 86 to warn if any combustible gases exceed predetermined levels. The separated water in the body 46 is then reused within the system 12 as described herein above.

Once the electrochemical cells 14 decompose the water, the hydrogen gas, mixed with water is processed by the HGMS 18. As best seen in FIG. 3, the HGMS 18 receives the water via manifold 90. A hydrogen water phase separator 92 causes nearly all the hydrogen gas to be separated from the liquid water. The hydrogen gas exits the separator 92 via conduit 94 while the water collects in the bottom of the separator 92. A back pressure regulator 154 described herein assures a minimum hydrogen gas pressure for delivery of product hydrogen gas and for return of water from the phase separator 92. By virtue of the pressurization a small amount of hydrogen gas is dissolved in the water. In the preferred embodiment, the water with dissolved hydrogen exits and is depressurized via valves 152 and the resultant mixture then flows via conduit 96 which returns to the oxygen-water phase separator 46. In an alternate embodiment, the water with dissolved hydrogen exits and is depressurized via valves 152 and conduit 96 and enters a hydrogen-water phase separator 150. In this alternate embodiment the resultant hydrogen gas is vented into the cabinet 38 and the water returns to the oxygen-water phase separator 46 via conduit 151. The hydrogen gas travels via conduit 94 to a dryer 98,99 which further dries the gas to a desired level, typically to less than 10 parts per million by volume at standard temperature and pressure. The dryers 98,99 are connected by a manifold 120 which alternates the hydrogen gas between the two dryers 98,99 on a predetermined time interval. These dryers, which are typically referred to as pressure swing or swing-bed type dryers regenerate one bed with a small slip stream of depressurized dry gas processed by the alternate dryer. After leaving the hydrogen gas driers 98, 99, the pressure of the hydrogen gas is measured by pressure sensor 155. The pressure sensor 155 provides a feedback to the control panel 28 for determining the appropriate amount of electrical power to provide to the electrochemical cells 14. The amount of electrical power provided by the control panel 28 determines the production rate of the electrochemical cells which in turn effects the output pressure of the hydrogen gas. By locating the pressure sensor 155 upstream from the pressure regulator 154, the control panel 28 is able to compensate for pressure fluctuations that result due to the cycling of the gas driers 98,99, phase separator 92 drain cycles and changes in customer demand. By controlling the pressure measured at pressure sensor 155 slightly above the set pressure of pressure regulator 154, the system 12 is able to maintain an output hydrogen gas pressure to the end user within ±0.5 bar without the use of a hydrogen buffer tank which was required hereto before. Typically, the control panel 28 operates to control the pressure at pressure sensor 155 at a point. 1 to 3 barg greater than the pressure regulator 154 set point. The hydrogen gas exits the system 12 via outlet 20 for use by the end-user.

As mentioned herein above, the system 12 also includes a ventilation system 22 which provides fresh air to the interior of the gas generation compartment 38. A fan 124 adjacent to a louvered grill 122 draws in external air. The air travels down the duct 126 and enters the interior portion of the gas generation compartment 38 adjacent the electrochemical cells 14. To exit the compartment 38, the air must traverse the length of the compartment 38 and exit through louvered grill 128. Due to the flow of air, the oxygen exhausted by the oxygen-water phase separator vent 86 is quickly removed from the system 12. Any hydrogen which escapes, such as hydrogen vented from the phase separator 150, is exhausted into the flow of air, diluted and quickly removed from system 12. Sensor 160 detects a loss of air ventilation and automatically causes the system 12 to shut down, stopping the production of oxygen and hydrogen. Additionally, a combustible gas sensor 130 is positioned adjacent to the exit grill 128. In the event that combustible gas levels in the vent air stream reach unacceptable levels, the system 12 is automatically shut down for maintenance or repair.

Combustible gas sensors such as sensors 130 and 88, typically use a technology referred to as a “catalytic bead” type sensor (commercially available under the tradename Model FP-524C by Detcon, Inc.). These sensors monitor the percentage of lower flammable limit (“LFL”) of combustible gas in a product gas stream. This LFL measurement represents the percentage of a combustible gas, such as hydrogen, propane, natural gas, in a given volume of air (e.g. the LFL for hydrogen in air is 4% by volume). These sensors 88, 130 require periodic calibration to ensure adequate performance. Calibration procedures typically require a user to use a bottle of premixed calibration gas which is manufactured with a predetermined mixture of hydrogen and air. The mixture is usually 25-50% of the lower flammable limit of the combustible gas. In the preferred embodiment of the present invention, the system 12 is configured to either automatically calibrate the sensors on a periodic basis, or to facilitate manual calibration by eliminating the need for the user to access the gas generation compartment. The auto-calibration system 30 of the preferred embodiment includes a bottle of premixed calibration gas 132, a solenoid valve block 134, an external port 136 and conduits 138, 140, 142, 143.

In operation, the combustible gas calibration system 30 is triggered either when activated by the user via the interface panel 28 or at a predetermined interval by the control panel 26. If the activation is triggered by the interface panel, the user is given the choice of either manually connect an external calibration bottle to port 136 or use the internal calibration gas 132. If the user selects to use the external bottle, they are instructed by the interface panel 28 to connect the bottle. If the user selects to use the internal calibration gas, the control panel 26 opens a solenoid valve 144 in the valve block 134 to allow the combustible gas mixture into conduits 138, 140. Orifices 145, 146 in conduits 138 and 140 respectively are sized to allow the appropriate amount of gas into the conduit. The gas travels along the conduits 138, 140 to the combustible gas sensors 88, 130. The control panel 26 monitors the levels of combustible gas measured by the sensors 88, 130. If the level measured is not equal to the level present in the premixed calibration gas, the control panel adjusts the combustible gas sensors 88, 130 until the appropriate levels are reached.

If the calibration is triggered by the expiration of the predetermined time limit, the sequence operates essentially the same as described above. If the calibration settings of out of adjustment by a predetermined amount, the control panel may optionally signal a warning to advise the user and/or shorten the time period between calibrations.

In the event that abnormal operating conditions or parameters such as the combustible gas sensor calibration are detected, the system 12 contains a number of health monitoring processes which allow for corrective actions to automatically adjust the operation of the system 12. In the preferred embodiment of the system 12, a number of the components, such as the electrochemical cell 14 or the power supplies are modular. This modularity provides an additional benefits in the event that a fatal error occurs in one module. As will be described in more detail herein, when a fatal error occurs, the system 12 is enabled to adjusted the operation of the system to accommodate the error and perform in a degraded mode until repairs or maintenance can be performed. This allows the end-user to continue operation without a major impact on their processes.

In order to perform the prescribed functions and desired processing, as well as the computations therefore (e.g. the control algorithms for hydrogen generation, and the like), control panel 26 and the power supplies 24 may include, but not be limited to, a processor(s), computer(s), memory, storage, register(s), timing, interrupt(s), communication interface(s), and input/output signal interfaces, and the like, as well as combinations comprising at least one of the foregoing. For example, control panel 26 may include input signal processing and filtering to enable accurate sampling and conversion or acquisitions of such signals from communications interfaces. Additional features of control panel 26 and certain processes, functions, and operations therein are thoroughly discussed at a later point herein.

During a normal mode of operation, the power supplied from the power supplies 24 to the control panel 26 and the electrochemical cells 14 to produce hydrogen gas as described herein above. In addition to the processing functions previously discussed, control panel 26 may also include power distribution components, such as but not limited to, circuit breakers, relays, contactors, fuses, dc-dc power conditioners, and the like, as well as combinations comprising at least one of the foregoing. These power distribution components allow power to be provided to components, such as pumps, fans and solenoid valves, within the system 12. During normal mode, current is varied to the electrochemical cells 14 to provide the appropriate product level of hydrogen gas required by the user.

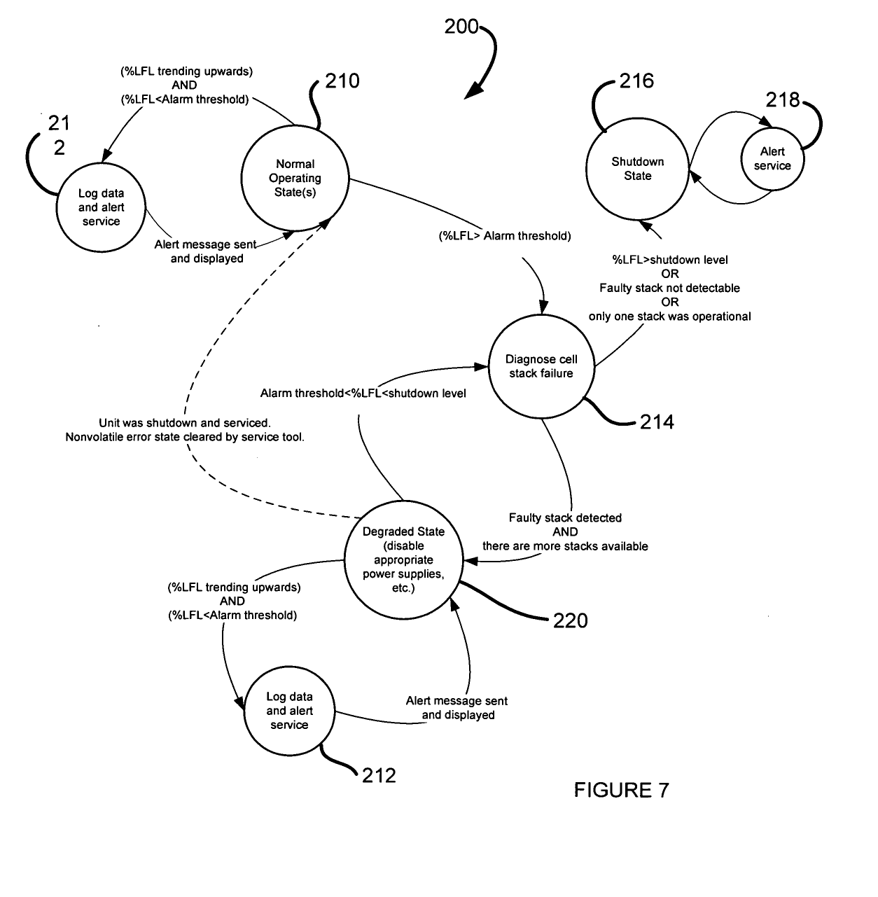

Referring to FIG. 7, a state transition diagram depicting an exemplary method of control process 200 for the system 12 is provided. The process 200 includes numerous modes and the criterion, requirements, events and the like to control changes of state among the various modes. The process 200 typically operates in normal mode 210 monitoring and evaluating various sensors and states to ascertain the status of the system 12. Such monitoring may include the evaluation of combustible gas levels in the vent stream from sensors 88, 130. If the percentage of the lower flammability limit (hereinafter referred to as “LFL”) trends upwards over time and the level of LFL remains below a threshold, the process 200 transfers to a log mode 212 which records the LFL data and sends a warning to the user interface 28.

Should the process 200 detect that the LFL exceeds a predetermined threshold, which may an indicate that repair or preventative action is needed, the process transfers to diagnostic mode 214 to evaluate the electrochemical cells 14. To determine if the high LFL measurement is due to a faulty or worn electrochemical cell 14, the diagnostic mode 214 operates each electrochemical cell 14 individually while monitoring the LFL measurements from sensor 88, 130. If the LFL measurements is greater than a shutdown level, or if the LFL measurements do not drop, or if there is only one electrochemical cell 14 is operating then the process 200 transfers to shutdown mode 216 to stop the processes of system 12 in an orderly manner. Process 200 uses alert mode 218 to notify the user.

If the diagnostic mode 214 determines which electrochemical cell 14 is responsible for the high LFL levels, then the process 200 transfers to degraded mode 220. The degraded mode 220 turns off the appropriate modules in the power supply 24 to remove electrical power from the faulty electrochemical cell 14 from operation. Log mode 212 records the appropriate data and alerts the user. Once the system 12 has been shut down and properly services, process 200 is reset to a normal mode 210.

Another error state which may be encountered by the system 12 is excessive water temperature in the manifold 58. Temperature measurements from the sensor 70 are acquired, monitored and analyzed by process 200 while in the normal operating mode 210. If normal mode 210 detects that the temperature is trending upwards and the actual water temperature is less than a predetermined threshold, the process 200 transfers to log mode 212 where the information is recorded and sends warning to the user.

If the water temperature measured by sensor 70 exceeds a predetermined threshold, the process 200 transfers to degraded mode 222. In degraded mode 222, the electrical current output of power supplies 24 is reduced to lower the hydrogen gas output of the electrochemical cells 14. The process 200 transfers to log mode 212 to log the temperature information and warn the user of the degraded performance of the system 12. Once the system 12 has been shut down and properly services, process 200 is reset to a normal mode 210. If the temperature measured by sensor 70 remains above a second predetermined threshold, typically equal to the maximum operating temperature of the guard bed 66, the process 200 transfers to shut down mode 216 to stop the processes of system 12 in an orderly manner. Process 200 uses alert mode 218 to notify the user.

Another error condition which may be experienced by the system 12 is a low voltage or high voltage condition in the electrochemical cells 14. If normal mode 210 detects an upward or downward trend in the voltage, the process 200 transfers to log mode 212 which records the information and sends a warning to the user. If the voltage required to operate the electrochemical cells 14 drops below a threshold, rises above a threshold and there is current being drawn by the electrochemical cells 14, the process 200 transfers to diagnostic mode 228 to determine which electrochemical cell is operating outside of normal parameters. If there is only one electrochemical cell 14 operating, process 200 transfers to shutdown mode 216 to stop the processes of system 12 in an orderly manner. Process 200 uses alert mode 218 to notify the user.

If there are more than two electrochemical cells 14 available, process 200 transfers to degraded mode 226 which disables the power supplies which provide electrical power to the faulty electrochemical cell and continues to operate the system 12 with the remaining electrochemical cells. Degraded mode 226 continues to monitor and analyze the electrochemical cell voltages and similar to the operation described above if an upward or downward trend is detected, the process 200 transfers to log mode 212 records the information and sends a warning to the user. Once the system 12 has been shut down and properly services, process 200 is reset to a normal mode 210. If the voltages once again rise above the predetermined thresholds, or fall below a predetermined threshold, the process 200 once again transfers to diagnostic mode 228 and repeats the sequence describe above once again. This process continues until the system 12 is repaired or reset, or until the last electrochemical cell is determined to be faulty.

Another error which the system 12 may encounter is a faulty power supply module in the power supply 24. If the process 200 while in normal mode 210 detects a power supply failure, the process 200 transfers to diagnostic mode 230. The diagnostic mode 230 interrogates each of the modules in the power supply 24 to determine which of the individual modules are faulty. Once the diagnostic mode 230 determines which module is faulty, the process 200 transfers to degraded mode 232 which disables the faulty power supply modules and continues operation. It should be appreciated that if multiple power supply modules are required to operate a single electrochemical cell 14, then degraded mode 232 will disable all the power supply modules associated with the faulty module. The process 200 also transfers to log mode 212 to record the appropriate power supply information and send a warning to the user. The process 200 then continues the operation of the system 12 in degraded mode. Once the system 12 has been shut down and properly services, process 200 is reset to a normal mode 210. If another power supply should fail, the sequence of modes repeats when the process 200 transfers back to diagnostic mode 230. In the event that there are not enough power supply modules remaining to operate a single electrochemical cell 14, then the process 200 transfers to shutdown mode 216 to stop the processes of system 12 in an orderly manner. Process 200 uses alert mode 218 to notify the user.

The last example of an error that may be encountered by the system 12 is a low inlet dionized water flow. In order to maintain operation of the system 12, a steady supply of fresh dionized water is typically required. If the flow of dionized water should be reduced or stop due to a problem with the external supply of water 17 then the system may be damaged if there is not enough dionized water to supply the electrochemical cells 14. Water flow from dionizer 17 is determined by measure the amount of time is required to change the level of water measured by sensor 48 in the oxygen-water phase separator 46. If normal mode 210 determines that the flow rate of the inlet dionized water is too low, the process 200 transfers to diagnostic mode 234 which determines what hydrogen gas production rate can be achieved with the available dionized water inlet flow. The process 200 then transfers to degraded mode 236 which reduces the current produced by the power supplies 24 to reduce the hydrogen production rate of the electrochemical cells 14. Degraded mode 236 continues to monitor and analyze the dionized water inlet flow in the manner described above. Once the system 12 has been shut down and properly services, or if the flow of dionized water flow returns to a normal operating state, the process 200 is reset to a normal mode 210. If the water flow continues to trend downward, the process 200 transfers to log mode 212 records the information and sends a warning to the user.

If the inlet water flow declines below a second threshold, the process 200 transfers back to the diagnostic mode 234 and the sequence repeats as described above until the inlet flow falls beneath a minimum operating level. Once the minimum operating level is achieved, the process 200 transfers to shutdown mode 216 to stop the processes of system 12 in an orderly manner. Process 200 uses alert mode 218 to notify the user.

While preferred embodiments have been shown and described, various modifications and substitutions may be made thereto without departing from the spirit and scope of the invention. For example, while the embodiments shown referred specifically to an electrochemical system have three electrochemical cells, it would also equally apply to a system having two, four or more electrochemical cells. Accordingly, it is to be understood that the present invention has been described by way of illustrations and not limitation.

1. An electrochemical system comprising:
a plurality of discrete electrochemical cell stacks;
a water-oxygen management system fluidly coupled to said plurality of electrochemical cell stacks; and,
a hydrogen management system fluidly coupled to said plurality of electrochemical cells.

2. The electrochemical system of claim 1 further comprising a control system for monitoring and operating said electrochemical system, said control system including a means for detecting abnormal operating conditions.

3. The electrochemical system of claim 2 wherein said control system further includes a means for degrading the performance of said electrochemical system in response to said abnormal condition.

4. The electrochemical system of claim 3 further comprising a means for ventilating said system.

5. An electrochemical system comprising:
a plurality of discrete electrochemical cell stacks; and,
a oxygen-water phase separator fluidly connected to said plurality of electrochemical cell stacks, said phase separator have a first manifold for discharging water to said electrochemical cell stacks and second manifold for receiving water from said electrochemical cell stacks, said first manifold including a plurality of cell stack outlets for discharging water to said electrochemical cells and a guard bed outlet.

6. The electrochemical system of claim 5 further comprising an exhaust conduit fluidly coupled to said phase separator, said conduit including an inlet for receiving a gas stream from said phase separator and an exhaust port for discharging said gas stream.

7. The electrochemical system of claim 6 further comprising a flow reducer coupled to said first manifold guard bed outlet, said flow reducer restricts the volume of water through said guard bed outlet over a range of pressures.

8. A system for automatically calibrating combustible gas sensors comprising:
a user interface;
a control panel connected to said user interface;
a canister of premixed combustible gas; and,
at least one combustible gas sensor electrically coupled to said control panel.

9. The system for automatically calibrating combustible gas sensors of claim 8 further comprising a valving arrangement fluidly coupled to said canister and said at least one combustible gas sensor.

10. The system for automatically calibrating combustible gas sensors of claim 10 wherein said valving arrangement is electrically connected to said control panel.

11. A method for automatically calibrating a combustible gas sensor comprising:
discharging premixed combustible gas at a predetermined interval;
injecting said premixed combustible gas onto the sensing surface of a combustible gas sensor; and,
measuring the level of combustible gas detected by the sensor.

12. The method for automatically calibrating a combustible gas sensor of claim 11 further comprising the step of automatically adjusting the calibration of the sensor in response to said measurement.

13. A system for controlling the output pressure of an electrochemical system, said system comprising:
At least one electrochemical cell;
a pressure regulator having a set point, said pressure regulator being fluidly coupled to said electrochemical cell;
a pressure sensor fluidly coupled to said pressure regulator between said pressure regulator and said electrochemical cell; and,
a means for controlling output of a electrochemical cell response to said pressure sensor wherein the pressure at said pressure sensor is maintained at a predetermined pressure above said pressure regulator set point.

14. The system for controlling the output pressure of an electrochemical system of claim 13 wherein said means for controlling output includes a control panel monitoring said pressure sensor.

15. A method of controlling an electrochemical cell system comprising:
operating a plurality of electrochemical cells;
supplying electrical power from a plurality of power supplies electrically connected to said plurality of electrochemical cells;
monitoring the operation of said plurality of electrochemical cells and said plurality of power supplies with a control system;
detecting an error state; and,
adjusting operation of said control system to accommodate said detected error state.

16. The method of controlling an electrochemical cell system of claim 15 wherein said error state is a failed power supply and said adjusting operation includes reducing the output of one of said plurality of electrochemical cells.

17. The method of controlling an electrochemical cell system of claim 15 wherein said error state is a high LFL measurement and said adjusting operation includes the step of determining which electrochemical cell is generating high LFL levels.

18. The method of controlling an electrochemical cell system of claim 17 wherein said method of determining which electrochemical cell is generating high LFL level includes the step of providing electrical power to single electrochemical cell of one of said plurality of electrochemical cells.

19. The method of controlling an electrochemical cell system of claim 18 further comprising the step of measuring the LFL level of gas produced by said single electrochemical cell.

20. The method of controlling an electrochemical cell system of claim 15 wherein said error state is an excessive water temperature and said adjusting operation includes reducing the output of said plurality of power supplies.

21. The method of controlling an electrochemical cell system of claim 15 wherein said error state is a failure in one of said plurality of power supplies and said adjusting operation includes determining which single power supply is failed and disabling said power supply.
